(19) United States
(12) Patent Application Publication
(10) Pub. No.: US 2022/0008176 A1
(43) Pub. Date: Jan. 13, 2022

(54) Flossing Tool

(71) Applicants: Leonhardt ANDERSEN, Erie, PA (US); William MOROSKY, Erie, PA (US)

(72) Inventors: Leonhardt ANDERSEN, Erie, PA (US); William MOROSKY, Erie, PA (US)

(21) Appl. No.: 17/298,595

(22) PCT Filed: Nov. 29, 2019
(86) PCT No.: PCT/US19/63870

§ 371 Date: May 30, 2021

Related U.S. Application Data
(60) Provisional application No. 62/772,783, filed on Nov. 29, 2018.
(60) Provisional application No. 62/802,216, filed on Feb. 7, 2019.
(60) Provisional application No. 62/814,102, filed on Mar. 5, 2019.
(60) Provisional application No. 62/924,598, filed on Oct. 22, 2019.

(51) Int. Cl. A61C 15/04

(52) U.S. Cl. CPC A61C 15/048

(57) ABSTRACT

An adjustable flossing tool includes a tool body having a major tool axis and a headstock. At least one string positioner having first and second positioner arms is positioned on the headstock. A floss string extends from the first positioner arm to the second positioner arm of each string positioner. Adjustment can be made to position the first string in a first string position in parallel to or at an angle to the major tool axis. Adjustment can also be made to position the first string to a second string position, the second string position being different from the first string position relative to the major tool axis.

### BACKGROUND

Flossing tools are used to enable users to more easily and effectively floss to remove food particles and plaque from between teeth and gums. However, prior flossing tools are limited in their utility in that they do not allow for the accommodation of different or variable flossing angles.

Referring to the drawings, FIG. 1 depicts a flossing tool 2 of the prior art having a handle or tool body 4 defining a major tool axis 8 and a first distal end 10. A first arm 12 and a second arm 14 extend from the first distal end 10. A first floss string 16 and a second floss string 18 extend between the first and second arms 12 and 14 for the flossing function. Although positioned at an angle from the major tool axis 8, the floss strings 16 and 18 cannot be adjusted from this angle relative to the major tool axis 8. As a result, the tool 2 may not allow for optimum flossing positioning for all teeth or flossing circumstances.

FIG. 2 depicts a flossing tool 19 of the prior art also having a handle or tool body 20 defining a major tool axis 22 and a first distal end 24 having a headstock 28. The headstock 28 includes a female locking keyslot (not shown in FIG. 2) allowing for the locking engagement of a removable string positioner 26 (shown both attached to the headstock 28 of the flossing tool 19 and removed therefrom in FIG. 2) with a male key segment 36. However, when the string positioner 26 is attached to the flossing tool 19, the first positioner arm 32 and second positioner arm 34 orient the single floss string 30 at a locked, roughly perpendicular position relative to the major tool axis 22. Thus, while the string positioner 26 is attached to the flossing tool 19 and in this locked position, no further adjustment of the position of the string 30 relative the major tool axis 22 is possible to optimize flossing.

### SUMMARY OF THE INVENTION

An adjustable flossing tool comprises a tool body having a major tool axis, the tool body having a first distal tool end and a headstock positioned at or near the first distal tool end. One or more string positioners having first and second positioner arms are positioned on the headstock. One or more floss strings are positioned to extend between the first and second positioner arms.

The headstock allows one or more string positioner to position a floss string in a first string position in parallel to or at an angle to the major tool axis. The headstock allows for tool adjustment, allowing at least one string positioner to position its floss string in a second string position in parallel to or at an angle to the major tool axis, the second string position being a different position than the first string position relative to the major tool axis.

In embodiments having two or more string positioners, at least one of the string positioners is positioned on the headstock. The string positioners may allow the floss strings to be positioned at 90 degrees to each other or at other angles relative to each other and/or to the major tool axis. The string positioners may be adjustable in their angles with respect to the major tool axis either by being removable and replaceable or by attached adjustment such as by rotation about either a shared or seperate axes or pivots.

### BRIEF DESCRIPTION OF THE DRAWINGS

For a more complete understanding and appreciation of this invention, and its many advantages, reference will be made to the following Detailed Description taken in conjunction with the accompanying drawings.

FIG. 1 depicts a flossing tool of the prior art;

FIG. 2 depicts a flossing tool of the prior art;

FIG. 3A depicts a perspective view of a flossing tool according to one embodiment of the invention;

FIG. 3B depicts a top view of the flossing tool of FIG. 3A;

FIG. 4 depicts a closeup top perspective view of the flossing tool of FIG. 3A;

FIG. 4A depicts a front view of a floss positioner according to one embodiment of the invention;

FIG. 4B depicts a side view of the floss positioner of FIG. 4A;

FIG. 5 depicts a closeup bottom perspective view of the flossing tool of FIG. 3A;

FIG. 6A depicts a top perspective view of a flossing tool according to one embodiment of the invention;

FIG. 6B depicts a bottom perspective view of a flossing tool according to one embodiment of the invention;

FIG. 6C depicts a perspective view of the floss positioner of FIG. 6A;

FIG. 6D depicts a perspective view of the floss positioner of FIG. 6B;

FIG. 6E depicts a perspective view of a floss positioner according to one embodiment of the invention;

FIG. 6F depicts a perspective view of a floss positioner according to one embodiment of the invention;

FIG. 6G depicts a top perspective view of a flossing tool according to one embodiment of the invention;

FIG. 6H depicts a top view of a flossing tool according to one embodiment of the invention;

FIG. 7A depicts a closeup top perspective view of a flossing tool according to one embodiment of the invention;

FIG. 7B depicts a closeup top perspective view of the flossing tool of FIG. 7A;

FIG. 8 depicts a closeup top perspective view of a flossing tool according to one embodiment of the invention;

FIG. 9 depicts a closeup top perspective view of a flossing tool according to one embodiment of the invention;

FIG. 10A depicts a closeup top perspective view of a flossing tool according to one embodiment of the invention;

FIG. 10B depicts a closeup bottom perspective view of a flossing tool according to one embodiment of the invention;

FIG. 11A depicts string positioner and string arrangement according to one embodiment of the invention;

FIG. 11B depicts string positioner and string arrangement according to one embodiment of the invention;

FIG. 11C depicts string positioner and string arrangement according to one embodiment of the invention;

FIG. 11D depicts string positioner and string arrangement according to one embodiment of the invention;

FIG. 11E depicts string positioner and string arrangement according to one embodiment of the invention;

FIG. 11F depicts string positioner and string arrangement according to one embodiment of the invention;

FIG. 11G depicts string positioner and string arrangement according to one embodiment of the invention;

FIG. 11H depicts string positioner and string arrangement according to one embodiment of the invention;

FIG. 11-I depicts string positioner and string arrangement according to one embodiment of the invention;

FIG. 11J depicts string positioner and string arrangement according to one embodiment of the invention;

FIG. 11K depicts string positioner and string arrangement according to one embodiment of the invention;

FIG. 11L depicts string positioner and string arrangement according to one embodiment of the invention;

FIG. 11M depicts string positioner and string arrangement according to one embodiment of the invention;

FIG. 11N depicts string positioner and string arrangement according to one embodiment of the invention;

FIG. 11-O depicts string positioner and string arrangement according to one embodiment of the invention;

FIG. 11P depicts string positioner and string arrangement according to one embodiment of the invention;

FIG. 11Q depicts string positioner and string arrangement according to one embodiment of the invention;

FIG. 11R depicts string positioner and string arrangement according to one embodiment of the invention;

FIG. 11S depicts string positioner and string arrangement according to one embodiment of the invention;

FIG. 11T depicts string positioner and string arrangement according to one embodiment of the invention;

FIG. 12A depicts a side view of a flossing tool according to one embodiment of the invention;

FIG. 12B depicts a top view of a flossing tool according to one embodiment of the invention;

FIG. 13 depicts a closeup side view of a flossing tool according to one embodiment of the invention;

FIG. 14 depicts a closeup side view of a flossing tool according to one embodiment of the invention;

FIG. 15 depicts a closeup side view of a flossing tool according to one embodiment of the invention;

FIG. 16 depicts a closeup side view of a flossing tool according to one embodiment of the invention;

FIG. 17 depicts a side view of a flossing tool according to one embodiment of the invention positioned to floss a user's teeth and gums;

FIG. 18 depicts a side view of a flossing tool according to one embodiment of the invention positioned to floss a use's teeth and gums;

FIG. 19 depicts a top perspective view of a Bossing tool according to one embodiment of the invention;

FIG. 20 depicts a top perspective view of the flossing tool of FIG. 19;

FIG. 21 depicts a top view of the flossing tool of FIG. 19;

FIG. 22 depicts a top view of the flossing tool of FIG. 19;

FIG. 23 depicts a top perspective view of a flossing tool according to one embodiment of the invention; and

FIG. 24 depicts a perspective view of a flossing tool according to one embodiment of the invention.

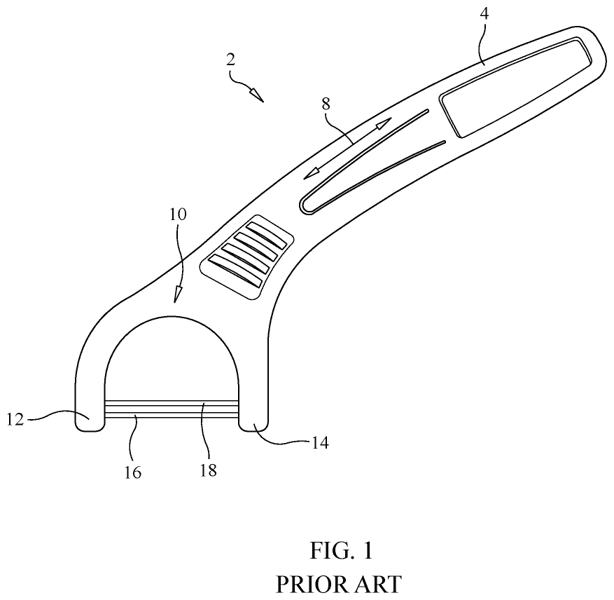

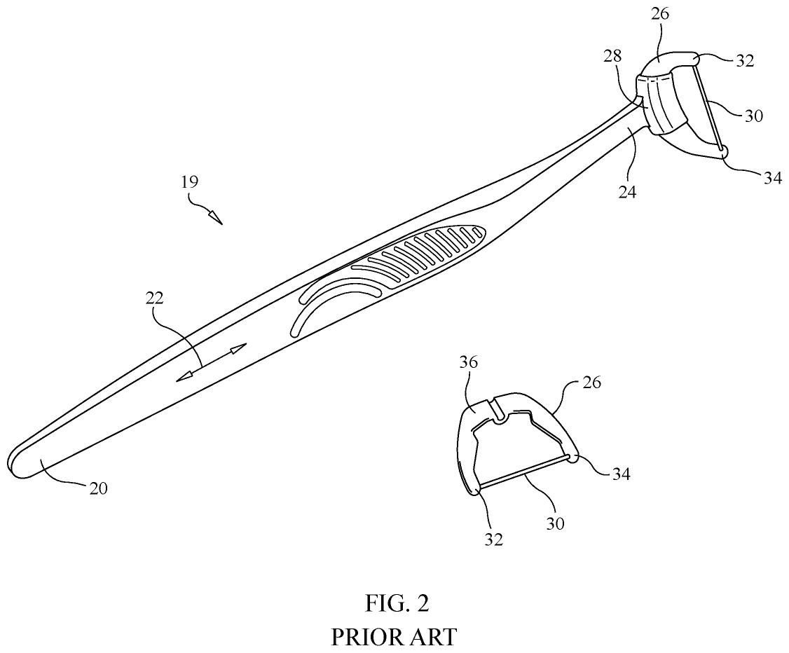

### DETAILED DESCRIPTION OF THE INVENTION

Referring to the drawings, similar reference numerals are used to designate the same or corresponding parts throughout the several embodiments and figures. In some drawings, some specific embodiment variations in corresponding parts are denoted with the addition of lower case letters to reference numerals.

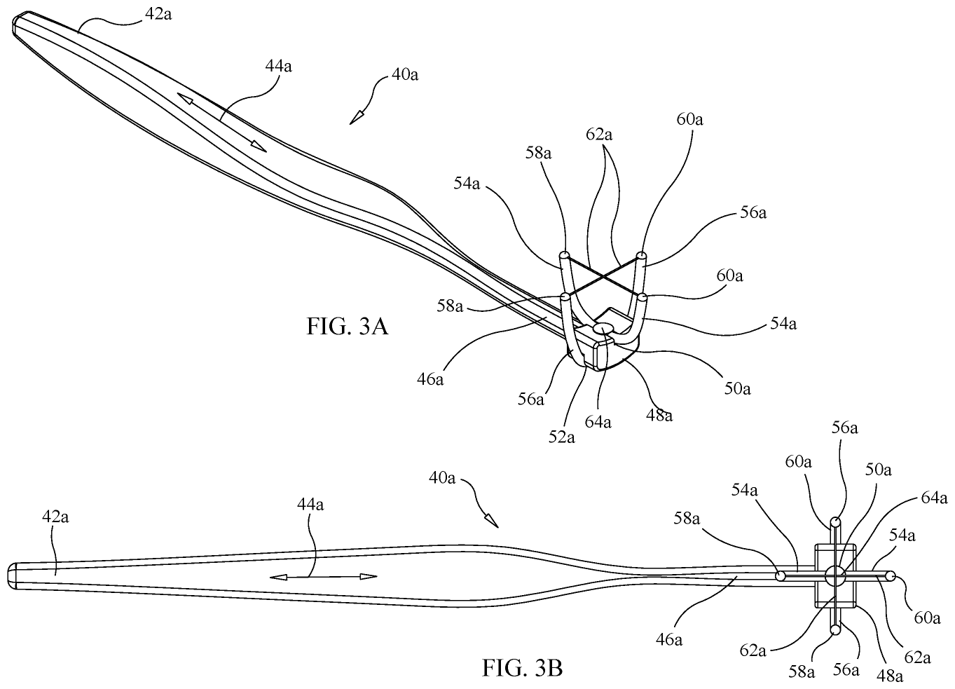

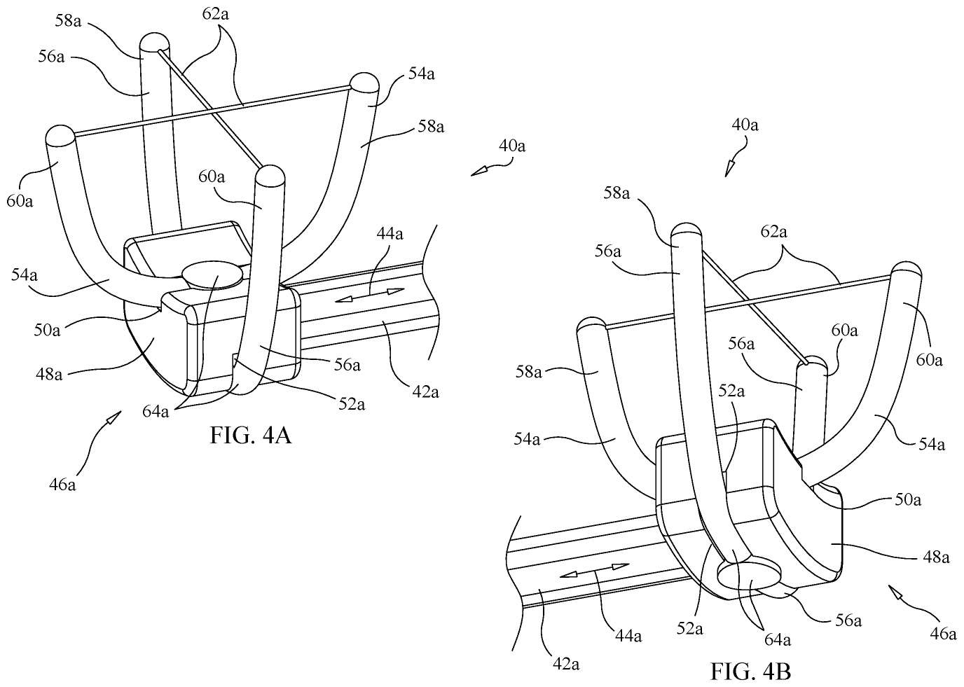

FIGS. 3A and 3B depict a flossing tool 40a having a handle or tool body 42a defining a major tools axis 44a and a first distal end 46a. The tool body 42a has a headstock 48a positioned at the first distal end 46a. Comparing FIGS. 3A and B with the close up perspective view of the first distal end 46a in FIG. 4, the headstock 48a includes a forward female positioning slot 50a and a back female positioning slot 52a. A first string positioner 54a and second string positioner 56a are positioned on the headstock 48a, each including a first positioner arm 58a and second positioner arm 60a and a floss string 62a.

With brief reference to the front view of the second string positioner 56a in FIG. 4A and the side view of the same second string positioner 56 in FIG. 4B, the floss string 62a extends from the first positioner arm 58n to the second positioner arm 60a. Male keying 64a is shaped into the second string positioner 56a at the location of connection between the first positioner arm 58a and second positioner arm 60a.

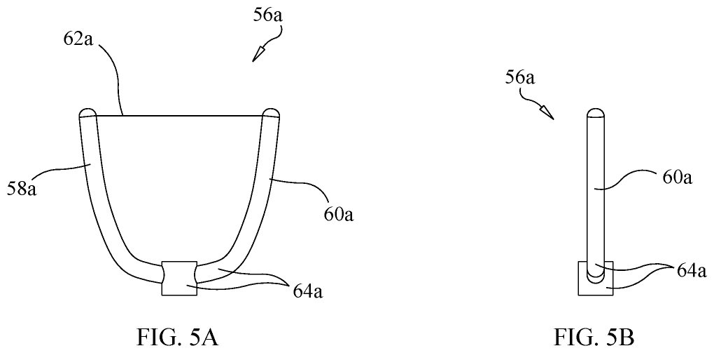

As best understood by comparing FIGS. 4A and 4B with FIGS. 4 and 5, the male keying 64a of the second string positioner 56a allows for lockable positioning of the second string positioner 56a within the back female positioning slot 52 of the headstock 48a. Similarly, the male keying 64a of the first string positioner 54a allows for lockable positioning of the first string positioner 54a within the forward female positioning slot 50S of the headstock 48a. This configuration allows both first and second string positioners 54a and 56a to be removable and easily re-installed in a locked position in the headstock 48A. When installed in their respective female positioning slots 50a and 52a as shown in FIGS. 4A and 4B, the string positioners 54a and 56 position their floss strings 62a in approximately perpendicular positions, and both floss strings 62a remain locked in such positions relative the major tool axis 44a.

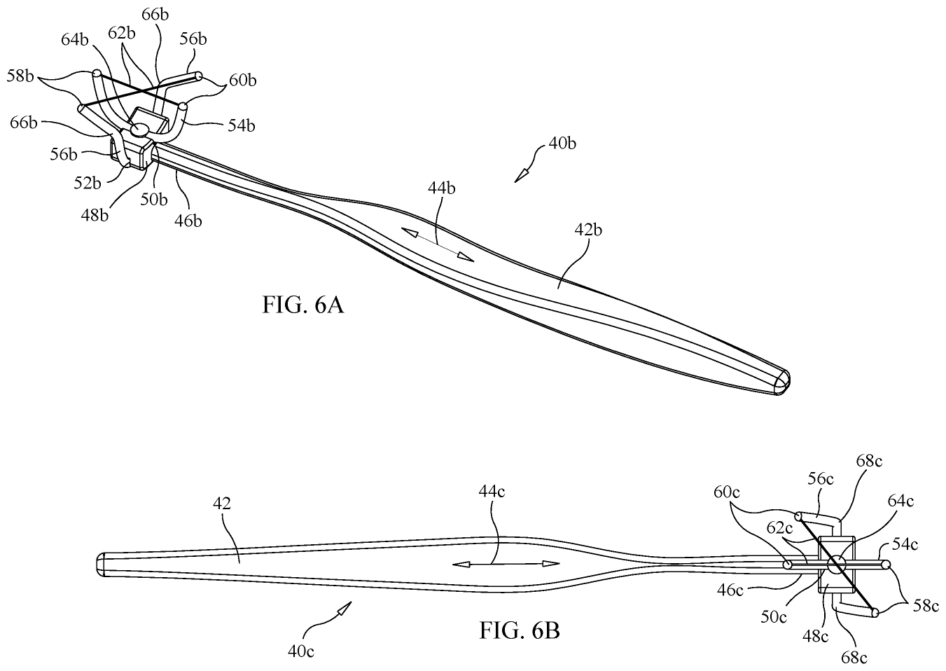

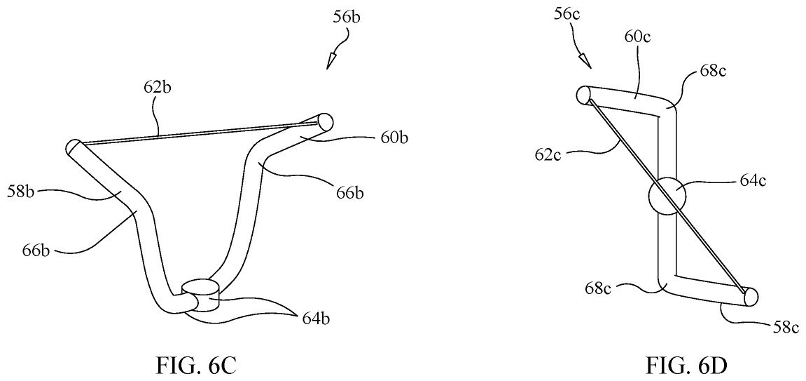

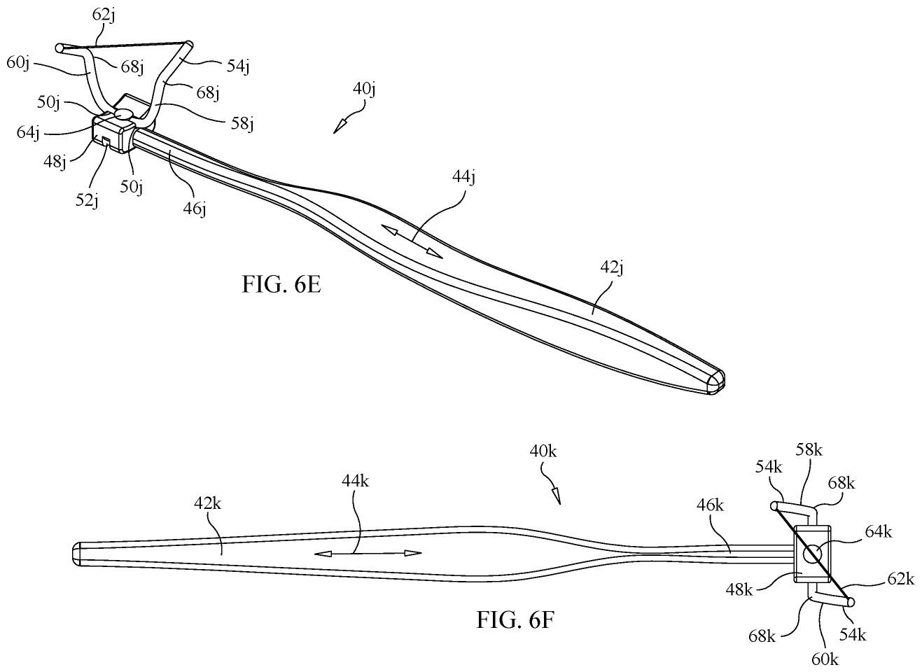

Although the embodiment of FIGS. 3A-5 has been shown and described with first and second string positioners 54a and 56a positioning strings 62a approximately perpendicularly at approximately 90-degree angles from each other, it will be appreciated that the invention contemplates adjustment of the flossing tool 40a by removal and replacement of the first and/or second string positioners 54a and/or 56a. For example, FIG. 6A depicts a perspective view of a flossing tool 40b similar to the flossing tool 40a of FIGS. 3A-5, having a first string positioner 54b and a second string positioner 56b the second string positioner 56b with a first positioner arm 58b and second positioner arm 60b each having a clockwise bend 66b. As best understood by comparing FIG. 6A with its removed first string positioner 54b depicted in FIG. 6C, the clockwise bends 66b of the positioner arms 58b and 60b result in a clockwise directional twist of the floss string 62b relative to the major tool axis 44b. The male keying 64b of the second string positioner 56b allows for removable and replaceable locking engagement of the back female positioning slots 52b in the headstock 48b. Thus, replacing the second string positioner 56, of FIGS. 3A, 3B, 4, and 5 with the second string positioner 56b of FIGS. 6A and 6C allows for tool adjustment and repositioning of the floss string 62b relative to the major tool axis 44b.

Opposite adjustment can also be achieved from removal and replacement of a second string positioner with opposite bends. For example, FIG. 6B depicts a top view of a flossing tool 40c similar to the flossing tool 40a of FIGS. 3A, 3B, 4, and 5 having a second string positioner 56c with a first positioner arm 58c and second positioner arm 60c each having a counterclockwise bend 68c. As best understood by comparing FIG. 6B with its removed second string positioner 56c depicted in FIG. 6D, the counterclockwise bends 68c of the positioner arms 58c and 60c result in a counterclockwise directional twist of the floss string 62c elative to the major tool axis 44c. The male keying 64c of the second string positioner 56c allows for removable and replaceable locking engagement of the back female positioning slots 52c in the headstock 48c. Thus, replacing the second string positioner 56a of FIGS. 3A, 3B, 4, and 5 with the second string positioner 56c of FIGS. 6B and 6D allows for tool adjustment and repositioning of the floss string 62c relative to the major tool axis 44c.

Although the invention has been shown and described as having multiple floss positioners, it will be appreciated that embodiments utilizing a single floss positioner are within the anticipated scope of the invention. For example, FIG. 6E depicts a flossing tool 40j of the invention having a first string positioner 54j locked into position by the forward female positioning slot 58j of the headstock 48j. The first positioning arm 58j and second positioning arm j have counterclockwise bends resulting in a counterclockwise directional twist of the floss string 62j relative to the major tool axis 44j. A back female positioning slot 52j remains unoccupied and open for reorienting or adding additional positioners. For example, FIG. 6F, depicts a flossing tool 46k of the invention having a first string positioner 54k locked into position by the back female positioning slot 52k of the headstock 48k. The first positioning arm 58k and second positioning arm 68k of the first string positioner 54k also have counterclockwise bends resulting in a counterclockwise directional twist of the floss string 62k relative to the major tool axis 44k. In both FIGS. 6E and 6F, the headstocks 48j and 48k allow for tool adjustment by allowing removal or replacement of the first string positioner 54j or 54k to reposition a floss string 62j or 62k relative the major tool axis 44j or 44k.

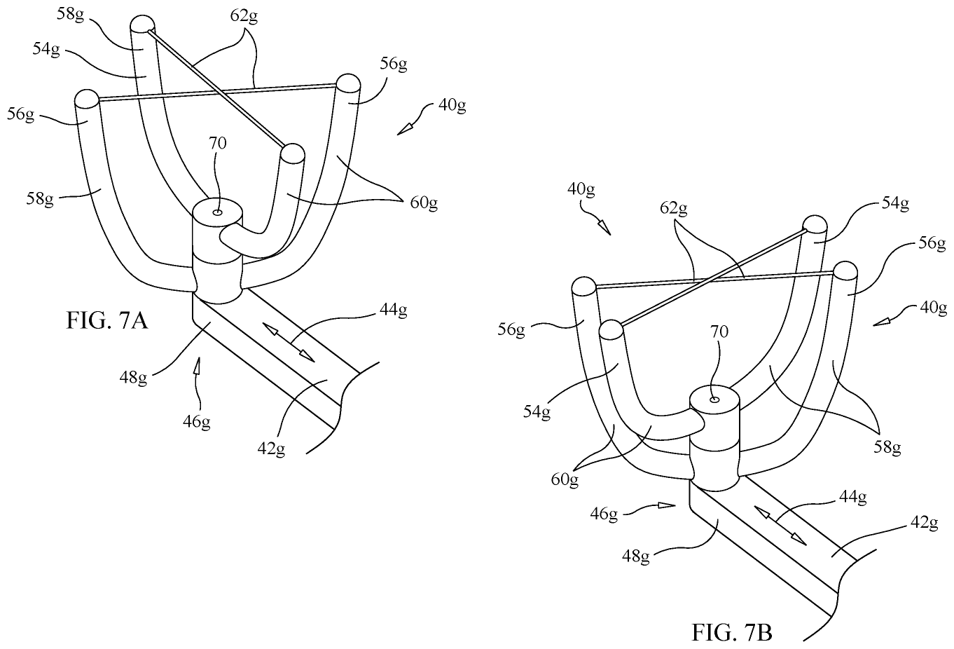

Although the invention has been shown and described with tool adjustment occurring via the removal and replacement of string positioners, it will be appreciated that adjustment can also occur without removal of tool components. For example, FIGS. 7A and 7B are top perspective views of a flossing tool 40g of the invention having both a first string positioner 54g and a second string positioner 56g positioned at the first distal end 46a of the tool body or handle 42g. Both the first string positioner 54g and second string positioner 56g are positioned to rotate on a lockable pivot 70 connecting the first and second string positioners 54g and 56g to the headstock 48g of the flossing tool 40g. This pivot mounting allows either or both of the first and second string positioners 54g and 56g to rotate about the pivot 76 for repositioning of the strings 62g relative to the major tool axis 44g. The pivot 70 can therefore lock the strings 62g approximately perpendicularly to each other, as shown in FIG. 7A, or at either closer or greater relative angles to each other, as shown in FIG. 7B. Similarly, both strings 62g can also be positioned at various positions relative the major tool axis 44g.

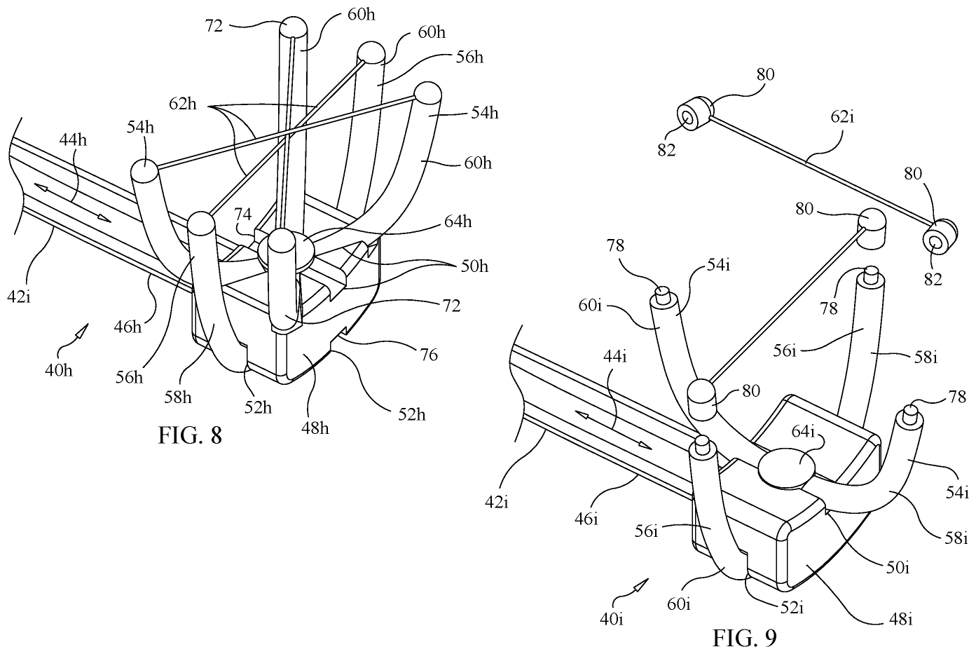

It will be further appreciated that embodiments having more than two strings and/or more than two string positioners are contemplated to be within the anticipated scope of the invention. For example, FIG. 8 depicts a flossing tool 40b of the invention having first and second string positioners 54h and 56i each having first and second positioner arms 58h and 60h and floss strings 62h. A third string positioner 72, having its own first and second positioner arms 58f and 60h, is also positioned to occupy and be locked in one of the forward female positioning slots 50 to suspend a third floss string 62h. The third floss positioner 72 can be a separate component, independently locked in the headstock 48h by its occupied female positioning slot 50b, or it can be joined, attached, or molded into the same structural body as the first string positioner 54h for added rigidity or simplification in design or manufacturing. An additional unoccupied forward female positioning slot 74 and an additional unoccupied back female positioning slot 76 are included in the headstock 48h for reorienting or adding additional string positioners.

It is further contemplated that some embodiments will allow for the removal or replacement of floss strings without full removal or replacement of the string positioners. For example, FIG. 9 depicts a floss tool 40i of the invention having locking pegs 78 positioned at the ends of each first and second positioning arm 58i and 60i of the first and second string positioners 54i and 56i. A suspension cap 80 is attached at each end of each floss string 62i and includes a locking hole 82 to engage, accommodate, and lock a corresponding peg 78i of the first or second string positioners 54i and 56i, thereby locking and positioning each floss string 62i on the string positioner 54i or 56i at a position with respect to the major tool axis 44i.

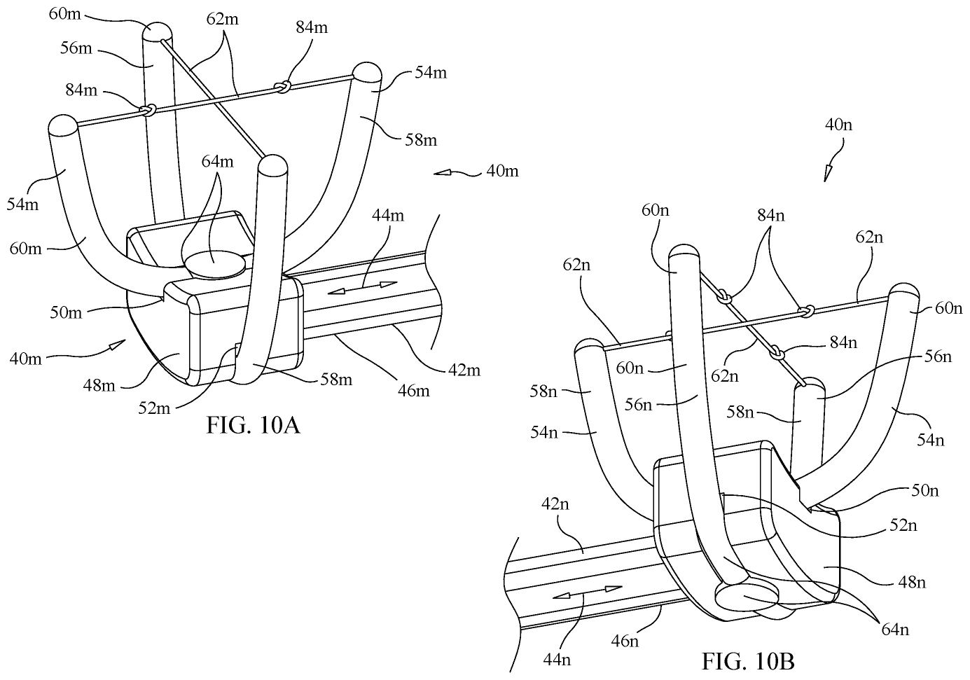

It will be further appreciated that modifications, variations, and functional improvements to the floss strings am anticipated within the contemplated invention scope. For example, braiding, knotting, and variations to string sizes and materials are contemplated. FIG. 10A depicts a flossing tool 40m in which the string 62, extending between the first and second positioner arms 58m and 60m of the first string positioner 54m has two string knots 84a for enhancing flossing action during use. The string 62m extending between the first and second positioner arms 58m and 60m of the second string positioner 56m lacks string knots, allowing for a variation in the relative flossing effects between the two floss strings 62m. In comparison, FIG. 10B depicts a similar flossing tool 40n in which both the floss strings 62n of the first and second string positioners 54n and 56n include two string knots 84n. Inclusion of the string knots 84n on both floss strings 62n allows for relative flossing effects between the two floss strings 62n to be mom balanced during use.

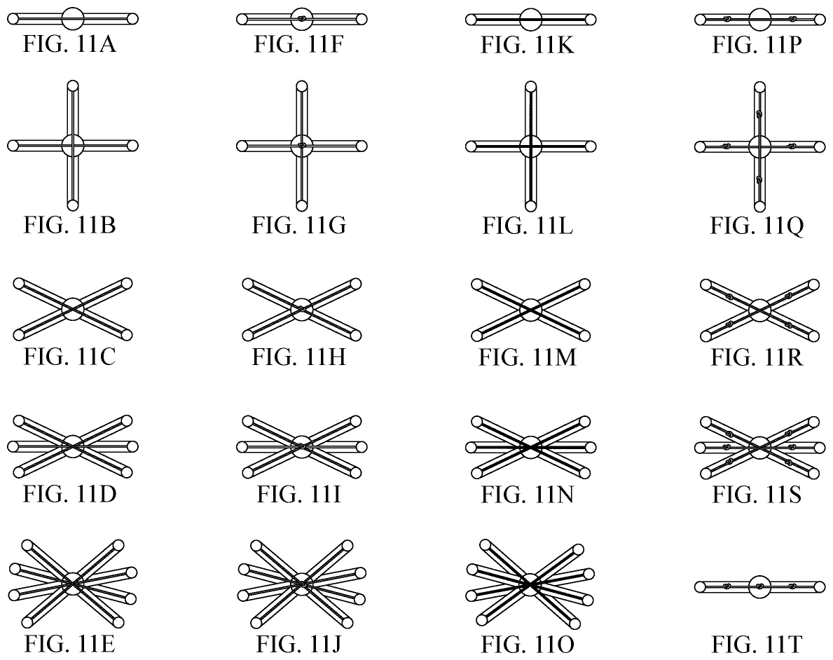

It will be appreciated that great variations between the numbers of string positioners/strings, arrangements, knot additions, and strings types are within the contemplated scope of the invention. For example, flossing devices of the invention may include single (FIG. 11A), double-90 degree (FIG. 11B), double non-90 degree (FIG. 11C), triple (FIG. 11D), quadruple (FIG. 11E), or a greater number string positioner/string combinations. Single mid-point knots may also be a feature of single (FIG. 11F), double-90 degree (FIG. 11G), double non-90 degree (FIG. 11H), triple (FIG. 11-I), quadruple (FIG. 11J), or greater numbered string positioner/string combinations, with midpoint knots joining separate string where two or more strings am present (FIGS. 11G, 11K, 11-I, and 11J). Braided string materials can also be used in single (FIG. 11K), double-90 degree (FIG. 11L), double non-90 degree (FIG. 11M), triple (FIG. 11N), quadruple (FIG. 11-O), or greater numbered string positioner/string combinations, with the separate strings remaining independent and unattached to different strings where two or more strings are present (FIGS. 11L, 11M, 11N, and 11-O). Multiple string knots may also be added to a single string for single (FIG. 11P), double-90 degree (FIG. 11Q), double non-90 degree (FIG. 11R), triple (FIG. 11S), quadruple (not shown), or a greater numbered string positioner/string combination, including string knots positioned both at the midpoint and at additional locations along a string (FIG. 11T).

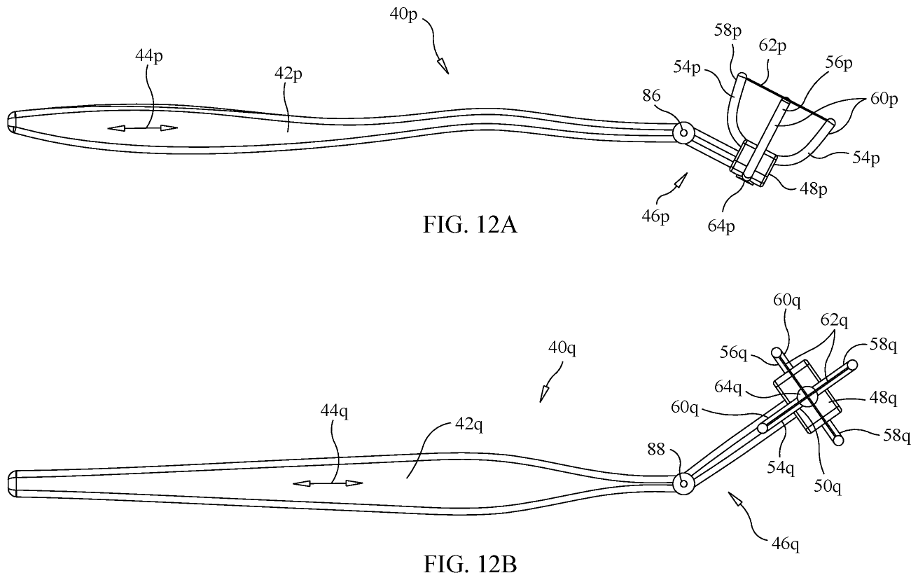

It is also possible within the contemplated invention scope to change the positioning of the strings relative the major tool dimension without removing the string positioners. For example FIG. 12A depicts side view of a flossing tool 48p in which the entire first distal end of the tool 40p is attached to the rest of the tool body or handle 40p with an inclination lock pivot 86. The inclination lock pivot 86 allows for the incline rotation of the entire headstock 48p and can be locked at any various selected inclined position relative to the major tool axis 44p. The headstock 48p therefore allows for tool adjustment by being selectively rotated about and locked by the lock pivot 86 to position the first and second string positioners 54p and 56p at different selected inclined positions, positioning the floss strings 62p relative the major tool axis 44p.

Other types of floss string positioning relative to the major tool axis are also within the contemplated scope of the invention. For example, FIG. 12B depicts top view of a flossing tool 40q in which the entire first distal end of the tool 46q is attached to the rest of the tool body or handle 40q with a lateral inclination lock pivot 88. The lateral lock pivot 88 allows for the lateral rotation of the entire headstock 48q and can be locked at any various selected lateral positions relative to the major tool axis 44q. The headstock 48q therefore allows for tool adjustment by being selectively laterally rotated about and locked by the lock pivot 86 to laterally position the first and second string positioners 54q and 56q at different selected lateral positions, positioning the floss strings 62q relative the major tool axis 44q.

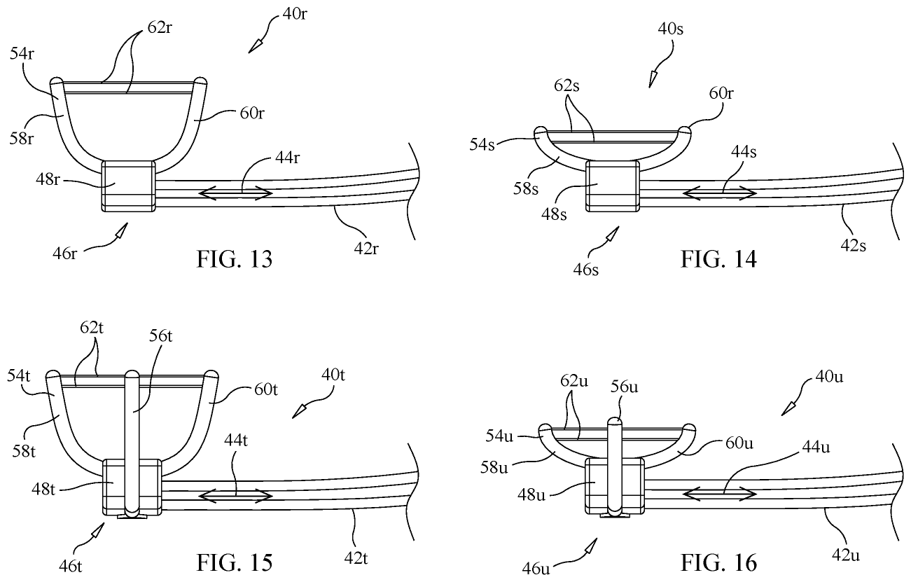

Variations in the number of strings positioned in parallel or on the same string positioner, and variations in the profile and/or orientations of the suing positioners themselves are also within the contemplated scope of the invention. For example, FIG. 13 depicts a side view of a flossing tool 40r of the invention having a single higher profile first string positioner 54r in which two parallel floss strings 62r extend between the first and second positioner arms 58r and 60r to enhance flossing effectiveness. The first and second positioner arms 58r and 60r are themselves longer to allow the first string positioner 54r to effect flossing with a greater clearance from the headstock 48r and tool body or handle 42r. A side view of a similar flossing tool 40s is depicted in FIG. 14. However, the depicted flossing tool 40s includes a single lower profile first string positioner 54s in which the two parallel floss strings 62s extend between shorter first and second positioner arms 58s and 60s to allow the first string positioner 54s to effect flossing with a less clearance from the headstock 48s and tool body or handle 42s.

Variations in profiles and numbers of parallel or same-string positioner strings are also within the contemplated invention scope. For example FIG. 15 depicts a side view of a flossing tool 40t in which two parallel floss strings 62t extend between the first and second positioner arms 58t and 60t of both first and second higher profile string positioners 54t and 56t. The first and second positioner arms 58t and 60t of both first and second string positioners 54t and 56t are longer to allow greater flossing clearance from the headstock 48t and tool body or handle 42t but with the added effectiveness of an additional flossing angle. In some embodiments, intersecting strings 62t of the first and second string positioners 54t and 56t may be attached or interconnected.

Although shown and described as including string positioners or parallel string groups of up to two strings, it will be appreciated that string positioners or more parallel string groups having three or more strings are also intended to be within the contemplated scope of the invention.

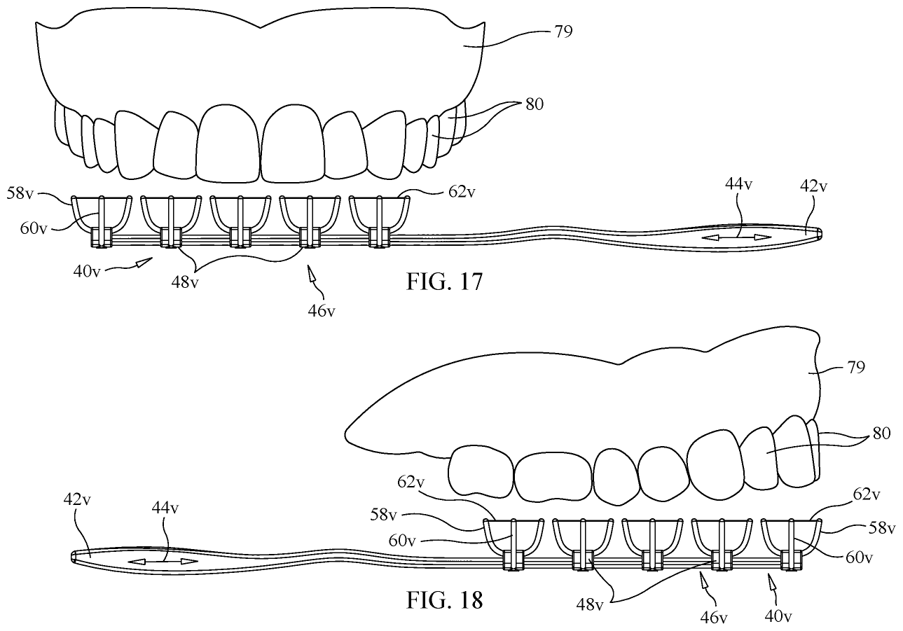

It will be similarly appreciated that two or more headstocks and/or pairings or greater combinations of string positioners are possible. For example, FIGS. 17 and 18 depict a side view of a flossing tool 46v of the invention having multiple headstocks 48v, each having its own pair of first and second string positioners 54v and 56v, positioned along the first distal end 46v of the tool body or handle 42v. Among the advantages of such an arrangement is the ability to floss between a user's gums 79 and several teeth 80 simultaneously from either the front, as depicted in FIG. 17, or from either side, as depicted in FIG. 18.

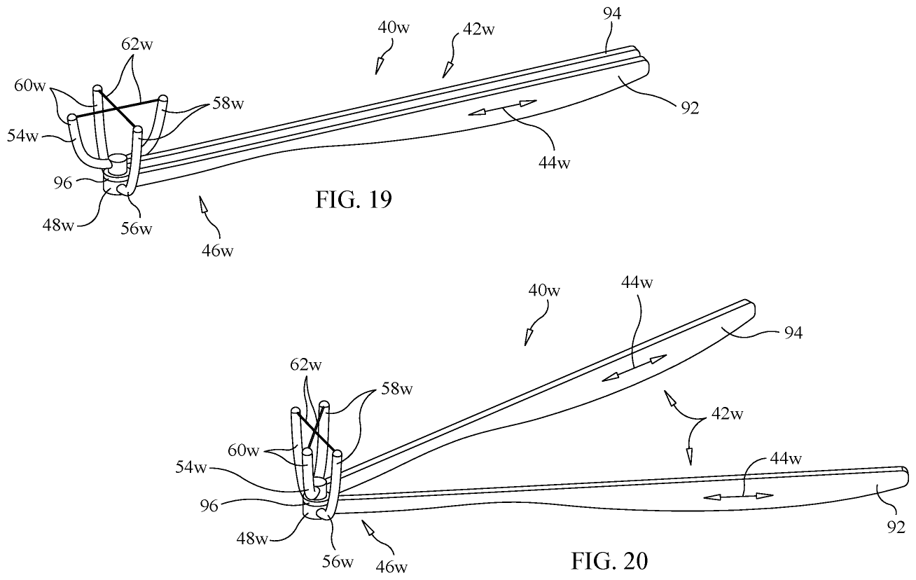

In some embodiments, adjustment of one or more floss strings relative to the major tool axis during tool use may be advantageous, and such embodiments are within the contemplated scope of the invention. For example, FIG. 19 depicts a top perspective view of a flossing tool 40w of the invention in which the tool body 42w is divided into a first handle 92 and second handle 94, the handles 92 and 94 connected at the first distal end 46w with a pivot link 96. The pivot link 96 forms a headstock 48w to which first and second string positioners 54w and 56w are attached. A major tool axis 44w may be defined by the major lengthwise dimension of either the first handle 92 or second handle 94.

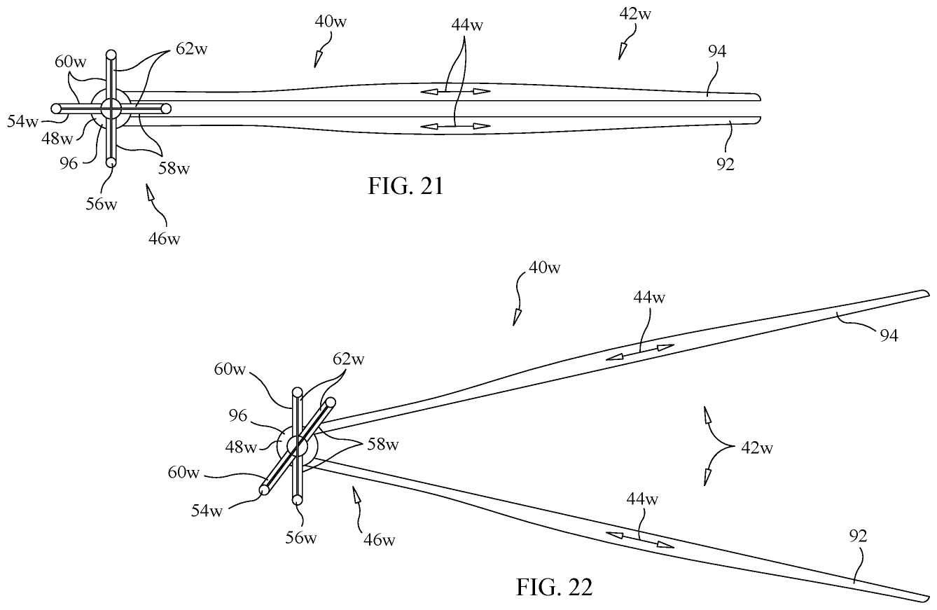

Comparing the top perspective views of the flossing tool 40w in FIGS. 19 and 20 with the top views of the flossing tool 40w in FIGS. 21 and 22, the first and second positioning arms 58w and 60w are positioned to orient the strings 62w at approximately 90 degrees, or about perpendicularly from each other, when the handles 92 and 94 are in the closed position, as shown in FIGS. 19 and 21. When the user rotates the handles 92 and 94 away from each other about the pivot link 96, the first and second string positioners 54w and 56w also rotate to a different relative angle, as shown in FIGS. 20 and 22. In this way, the user can adjust the positions of each string 62w relative to one major tool axis 44w.

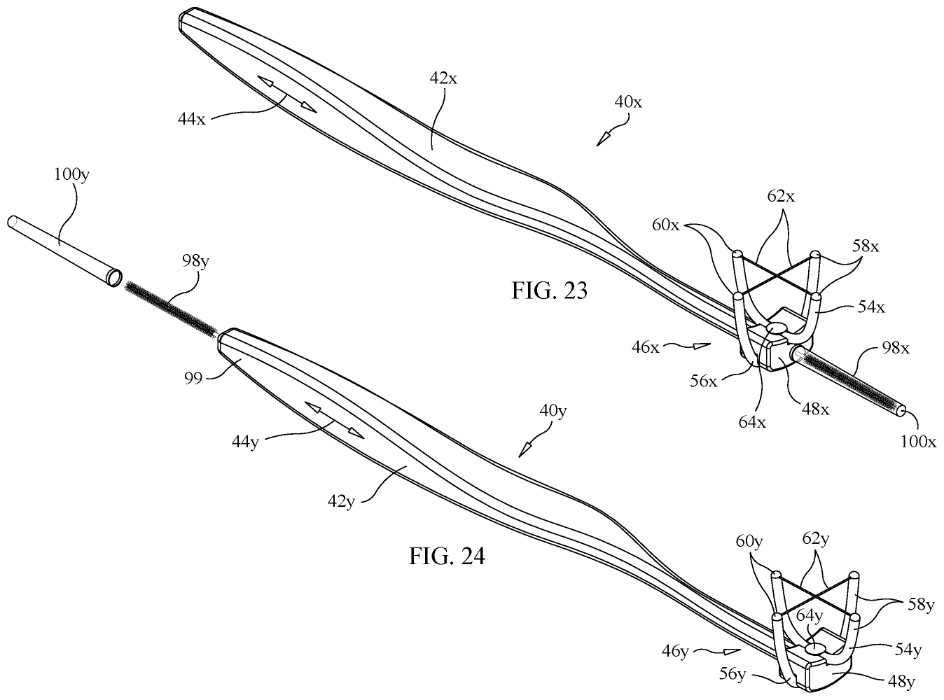

Additional accessory components can also be included as add-on flossing tool features within the anticipated invention scope. For example, FIG. 23 depicts a flossing tool 40x of the invention fitted with a gum brush 98x at the first distal end 46x of the tool body or handle 42x. The gum brush 98x is attached to and extends from the headstock 48x of the flossing tool 40x generally along the major tool axis 44x. This positioning enables the user to fully utilize the handle 42x in manipulating the brush 98x during gum cleaning. The brush 98x is optimally screwed into its position on the headstock 48x to enable removal during flossing operations. An elongated snap cap 100y, which, as shown, may be constructed of transparent molded plastic, is fitted over the gum brush 98x for hygienic protection during tool storage.

Referring now to FIG. 24, a similar flossing tool 40y of the invention is fitted with a gum brush 99x at the second distal end 99 of the tool body or handle 42y. The gum brush 98y is attached to and extends generally along the major tool axis 44y, which also enables the user to fully utilize the handle 42y in manipulating the brush 98y during gum cleaning, without requiring removal during flossing operations. The elongated snap cap 100y is shown in FIG. 24 removed from the brush for use.

Those skilled in the art will realize that this invention is capable of embodiments different from those shown and described. It will be appreciated that the detail of the structure of the disclosed apparatuses and methodologies can be changed in various ways without departing from the invention itself. Accordingly, the drawings and detailed description of the preferred embodiments are to be regarded as including such equivalents as do not depart from the spirit and scope of the invention.

1. An adjustable flossing tool comprising:
a tool body having a major tool axis, said tool body having a first distal tool end and a headstock positioned at or near said first distal tool end;
at least one first string positioner positioned on said headstock, said first string positioner having a first positioner arm and a second positioner arm;
at least one first floss string positioned to extend from said first positioner arm to said second positioner arm of at least one said first string positioner;
said headstock allowing at least one said first string positioner to position said first string in a first string position in parallel to or at an angle to said major tool axis, said headstock allowing for tool adjustment to allow at least one said first string positioner to position said first floss string in a second string position in parallel to or at an angle to said major tool axis; and
said first string position being different from said second string position relative to said major tool axis.

2. The flossing tool of claim 1 further comprising a rotatable locking pivot, said locking pivot attaching said at least one first string positioner to said headstock, said locking pivot allowing said at least one first string positioner to rotate and position said at least one first floss string in said first string position, said locking pivot allowing for tool adjustment by allowing said at least one first string positioner to rotate and position said at least one first floss string in said second string position.

3. The flossing tool of claim 1 further comprising said at least one string positioner being removable and replaceable to a locked angle relative to said major tool axis by said headstock.

4. The flossing tool of claim 1 further comprising at least one second floss string, said at least one second floss string being positioned parallel to at least one first floss string.

5. The flossing tool of claim 1 further comprising a knot in said at least one first floss string.

6. The flossing tool of claim 1 further comprising at least one second floss string, said at least one first floss string and said at least one second floss string being braided.

7. The flossing tool of claim 1 further comprising said at least one floss string being connected to said first positioner arm and said second positioner arm with removable string positioner tips.

8. The flossing tool of claim 1 further comprising a pivot joint in said tool body, said headstock being rotatable relative to said major tool axis, said pivot joint allowing said headstock and said at least one first string positioner to rotate said at least one floss string from said first string position to said second string position.

9. The flossing tool of claim 1 further comprising a second distal tool end and a gum brush positioned on said second distal tool end.

10. The flossing tool of claim 1 further comprising three or more said string positioners and three or more floss strings.

11. The flossing tool of claim 1 further comprising one or more second string positioners to allow said flossing tool to simultaneously floss multiple teeth.

12. The flossing tool of claim 1 wherein said at least one floss string is attached to said first positioner arm and said second positioner arm with interchangeable string positioner tips.

13. An adjustable flossing tool comprising:
a tool body having a major tool axis, said tool body having a first distal tool end and a headstock positioned at or near said first distal tool end;
a first string positioner and a second string positioner positioned on said flossing tool, each said first string positioner and said second string positioner having a first positioner arm and a second positioner arm, at least one of said first string positioner and said second string positioner being positioned on said headstock;
each of said first string positioner and said second string positioner having at least one first floss string positioned to extend from said first positioner arm to said second positioner arm;
said headstock allowing at least one of said first string positioner and said second string positioner to position a said first string at a first string position in parallel to or at an angle to said major tool axis, said headstock allowing for tool adjustment to allow at least one said first string positioner and said at least one second string positioner to position a said first floss string at a second string position in parallel to or at an angle to said major tool axis; and
said first string position being different from said second string position relative to said major tool axis.

14. The flossing tool of claim 13 further comprising a rotatable locking pivot, said locking pivot attaching at least one of said first string positioner and said second string positioner to said headstock, said locking pivot allowing at least one of said first string positioner and said second string positioner to rotate and position at least one said first floss string in said first string position, said locking pivot allowing for tool adjustment by allowing at least one of said first string positioner and said second string positioner to rotate and position at least one said first floss string in said second string position.

15. The flossing tool of claim 13 further comprising at least one of said first string positioner and said second string positioner being removable and replaceable to a locked angle relative to said major tool axis by said headstock.

16. The flossing tool of claim 13 further comprising said first string positioner and said second string positioner each having at least one second floss string, each said at least one second floss string being positioned parallel to each said first floss string.

17. The flossing tool of claim 13 further comprising at least one of said first string positioner and said second string positioner allowing said floss string to be positioned approximately perpendicularly.

18. The flossing tool of claim 13 further comprising a second floss string on at least one of said first string positioner and said second string positioner, said second floss string being positioned parallel to at least one first floss sing.

19. The flossing tool of claim 13 further comprising a knot in at least one of said first floss string and said second floss string.

20. The flossing tool of claim 13 wherein at least one said floss string is braided.

21. The flossing tool of claim 13 further comprising a pivot joint in said tool body, said headstock being rotatable relative to said major tool axis, said pivot joint allowing said headstock and at least one of said first string positioner and said second string positioner to rotate at least one said floss string from said first string position to said second string position.

22. The flossing tool of claim 13 further comprising a second distal tool end and a gum brush positioned on said second distal tool end.

23. The flossing tool of claim 13 further comprising three or more said string positioners and three or more floss strings.

24. The flossing tool of claim 13 further comprising three or more said string positioners and three or more floss strings.

25. The flossing tool of claim 13 wherein at least one said floss string is attached to at least one first positioner arm and at least one second positioner arm with interchangeable string positioner tips.

26. An adjustable flossing tool comprising:
a tool body having a major tool axis, said tool body having a first distal tool end and a headstock positioned at or near said first distal tool end;
at least one first string positioner and at least one second string positioner positioned on said flossing tool, each said at least one first string positioner and said at least one second string positioner having a first positioner arm and a second positioner arm, at least one of said first string positioner and said second string positioner being positioned on said headstock, at least one of said first string positioner and said second string positioner being removable from said flossing tool and replaceable with another said at least one said first string positioner or said at least one second string positioner;
each of said at least one first string positioner and at least one said second string positioner having at least one first floss string positioned to extend from said first positioner arm to said second positioner arm;
said headstock allowing at least one of said first string positioner and said second string positioner to position a said first string at a first string position in parallel to or at an angle to said major tool axis, said flossing tool allowing for tool adjustment by allowing removal and replacement of said at least one first string positioner or said at least one second string positioner to allow at least one of said first string positioner and said second string positioner to position at least one said first floss string at a second string position in parallel to or at an angle to said major tool axis; and
said first string position being different from said second string position relative to said major tool axis.

27. The flossing tool of claim 26 further comprising at least one of said first string positioner and said second string positioner allowing said floss string to be positioned approximately perpendicularly.

28. The flossing tool of claim 26 further comprising a second floss string on at least one of said first string positioner and said second string positioner, said second floss string being positioned parallel to at least one first floss string.

29. The flossing tool of claim 26 further comprising a knot in at least one of said first floss string and said second floss string.

30. The flossing tool of claim 26 wherein at least one said floss string is braided.

31. The flossing tool of claim 26 further comprising a pivot joint in said tool body, said headstock being rotatable relative to said major tool axis, said pivot joint allowing said headstock and at least one of said first string positioner and said second string positioner to rotate at least one said floss string from said first string position to said second string position.

32. The flossing tool of claim 26 further comprising a second distal tool end and a gum brush positioned on said second distal tool end.

33. The flossing tool of claim 26 further comprising a second distal tool end and a gum brush positioned on said second distal tool end.

34. The flossing tool of claim 26 wherein said first string positioner and said second string positioner are positioned to allow said flossing tool to simultaneously floss multiple teeth.

35. The flossing tool of claim 26 wherein at least one said floss string is attached to at least one first positioner arm and at least one second positioner arm with interchangeable string positioner tips.

36. An adjustable flossing tool comprising:
a tool body having a major tool axis, said tool body having a first distal tool end and a headstock positioned at or near said first distal tool end;
at least one first string positioner positioned on said headstock, said at least one first string positioner having a first positioner arm and a second positioner arm;
at least one first floss string positioned to extend from said first positioner arm to said second positioner arm of at least one said first string positioner;
said at least one first string positioner being attached to said headstock with a rotatable locking pivot, said locking pivot allowing at least one said first string positioner to rotate and position said at least one floss string in a first string position in parallel to or at an angle to said major tool axis, said locking pivot allowing for tool adjustment by allowing rotation of said at least one first string positioner to position said at least one first floss string in a second string position in parallel to or at an angle to said major tool axis; and
said first string position being different from said second string position relative to said major tool axis.

37. The flossing tool of claim 36 further comprising at least one of said first string positioner and said second string positioner allowing said floss string to be positioned approximately perpendicularly.

38. The flossing tool of claim 36 further comprising a second floss string on at least one of said first string positioner and said second string positioner, said second floss string being positioned parallel to at least one first floss string.

39. The flossing tool of claim 36 further comprising a knot in at least one of said first floss string and said second floss string.

40. The flossing tool of claim 36 wherein at least one said floss string is braided.

41. The flossing tool of claim 36 further comprising a pivot joint in said tool body, said headstock being rotatable relative to said major tool axis, said pivot joint allowing said headstock and at least one of said first string positioner and said second string positioner to rotate at least one said floss string from said first string position to said second string position.

42. The flossing tool of claim 36 further comprising a second distal tool end and a gum brush positioned on said second distal tool end.

43. The flossing tool of claim 36 further comprising three or more said string positioners and three or more floss strings.

44. The flossing tool of claim 36 wherein said first string positioner and said second string positioner are positioned to allow said flossing tool to simultaneously floss multiple teeth.

45. The flossing tool of claim 36 wherein at least one said floss string is attached to at least one first positioner arm and at least one second positioner arm with interchangeable string positioner tips.

46. An adjustable flossing tool comprising:
a tool body having first distal end, a headstock positioned at said first distal end, a first plier handle having a first major handle axis, and a second plier handle having a second major handle axis;
said second plier handle being rotatably attached to said first plier handle at a pivot point in said headstock;
a first string positioner attached in fixed position relative to said first plier handle and a second string positioner attached fixed position relative to said second plier handle, each said first string positioner and said second string positioner having a first positioner arm and a second positioner arm,
each of said first string positioner and said second string positioner having at least one first floss string positioned to extend from said first positioner arm to said second positioner arm;
said pivot point allowing said first string positioner to rotate at least one first floss string along with rotation of said first plier handle to a first string position relative to said second pier handle and said second major handle axis;
said pivot point allowing said second string positioner to rotate at least one first floss string along with rotation of said second plier handle to a second string position relative to said first plier handle and said first major handle axis; and
said first string position being different from said second string position relative to said second major handle axis.

47. The flossing tool of claim 46 further comprising said first string positioner and said second string positioner each having at least one second floss string, each said at least one second floss string being positioned parallel to each said first floss string.

48. The flossing tool of claim 46 further comprising at least one of said first string positioner and said second string positioner allowing said floss string to be positioned approximately perpendicularly.

49. The flossing tool of claim 46 further comprising a second floss string on at least one of said first string positioner and said second string positioner, said second floss string being positioned parallel to at least one first floss string.

50. The flossing tool of claim 46 further comprising a knot in at least one of said first floss string and said second floss string.

51. The flossing tool of claim 46 wherein at least one said floss string is braided.

52. The flossing tool of claim 46 further comprising a second distal tool end and a gum brush positioned on said second distal tool end.

53. The flossing tool of claim 46 wherein at least one said floss string is attached to at least one first positioner arm and at least one second positioner arm with interchangeable string positioner tips.

54. An adjustable flossing tool comprising:
a tool body having a major tool axis, said tool body having a first distal tool end and a headstock positioned at or near said first distal tool end;
a first string positioner and a second string positioner positioned on said flossing tool, each said first string positioner and said second string positioner having a first positioner arm and a second positioner arm, at least one of said first string positioner and said second string positioner being positioned on said headstock;
each of said first string positioner and said second string positioner having at least one first floss string positioned to extend from said first positioner arm to said second positioner arm;
a rotatable locking pivot, said locking pivot attaching at least one of said first string positioner and said second string positioner to said headstock, said locking pivot allowing at least one of said first string positioner and said second string positioner to rotate and position at least one said first floss string in a first string position relative to said major tool axis, said locking pivot allowing for tool adjustment by allowing at least one of said first string positioner and said second string positioner to rotate and position at least one said first floss string in a second string position relative to said major tool axis;
said first string position being different from said second string position relative to said major tool axis; and
said tool allowing said floss string of said first string positioner and said second string positioner to be positioned approximately perpendicularly.

55. A method for flossing comprising:
providing an adjustable flossing tool having a tool body with a major tool axis, the tool body having a first distal tool end and a headstock positioned at or near the first distal tool end;
providing at least one first string positioner positioned on the headstock, the first string positioner having a first positioner arm and a second positioner arm;
positioning at least one first floss string to extend from the first positioner arm to the second positioner arm;
positioning the first string positioner on the headstock to position the first floss string in a first string position in parallel to or at an angle to the major tool axis; and
adjusting the position of the string positioner on the headstock to move the first floss string from a first string position to a second string position in parallel to or at an angle to the major tool axis, wherein the first string position is different from the second string position relative to the major tool axis.

56. A method for flossing comprising:
providing an adjustable flossing tool having a tool body having a major tool axis, the tool body having a first distal tool end and a headstock positioned at or near the first distal tool end;
providing a first string positioner and a second string positioner and positioning the first string positioner and second string positioner on the flossing tool, each of the first string positioner and second string positioner having a first positioner arm and a second positioner arm;
positioning at least one of the first string positioner and second string positioner on the headstock of the flossing tool;
providing at least one first floss string for each of the first string positioner and second string positioner, and positioning each floss string to extend from the first positioner arm to the second positioner arm of one of the first string positioner and the second string positioner;
adjusting the position of at least one of the first string positioner and the second string positioner on the headstock to allow at least one of the first string positioner and the second string positioner to position a floss string at a first string position in parallel to or at an angle to said major tool axis; and
adjusting the position of at least one of the first string positioner and second string positioner on the headstock to move at least one first floss string from a first string position to a second string position in parallel to or at an angle to the major tool axis, wherein the first string position is different from the second string position relative to the major tool axis.
